(19) United States
(12) Patent Application Publication
(10) Pub. No.: US 2010/0154680 A1
(43) Pub. Date: Jun. 24, 2010

(54) PIGMENT GRANULES WHICH CONTAIN INORGANIC FILTER AIDS

(75) Inventors: Holger Friedrich, Newcastle (ZA); Herbert Kunstmann, Krefeld (DE); Krzysztof Chlopek, Krefeld (DE); Jüergen Kischkewitz, Ratingen (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/544,300

(22) Filed: Aug. 20, 2009

(30) Foreign Application Priority Data
Sep. 1, 2008 (DE) 10 2008 045 121.5

(51) Int. Cl. C04B 14/00; C04B 14/02; C04B 14/30; C09B 27/00; C09B 48/00; C04B 14/04; C08K 5/00; C04B 16/02; C04B 16/04; C04B 14/20; C08K 3/00

(52) U.S. Cl. 106/668; 106/400; 106/456; 106/459; 106/460; 106/436; 106/439; 106/447; 106/453; 106/425; 106/428; 106/429; 106/496; 106/497; 106/410; 106/494; 106/495; 106/482; 106/413; 106/489; 106/472; 106/474; 106/476; 106/503; 106/505; 106/501.1; 106/481; 106/502; 106/504; 106/417; 106/479; 106/450; 106/464; 106/463; 106/462; 106/419; 106/471; 106/712; 524/612; 524/597; 524/555; 524/560; 524/557; 524/585; 524/577; 524/546; 524/590; 524/599

(57) ABSTRACT

The present invention relates to pigment granules which contain inorganic filter aids and a process for the production thereof and their use for colouring lime- and/or cement-bound building materials, asphalt, paints, finishes, paper or plastics.

The present invention relates to pigment granules which contain inorganic filter aids and processes for the preparation thereof and their use for colouring lime- and/or cement-bound building materials, asphalt, paints, finishes, paper or plastics.

The processing of pigment granules requires milling of the pigments to primary particles for achieving the optimum colour impression. The resulting powders produce a very large amount of dust and, owing to their finely divided nature, tend to adhere and stick to packagings, machine parts and metering installations. In the case of toxicologically hazardous substances, it is therefore necessary during the processing to take measures for avoiding danger to persons and environment from resulting dusts. However, in the case of safe inert substances, such as, for example, iron oxide pigments, too, avoidance of dust pollution is being increasingly desired by the market.

Dust avoidance and improved metering based on good flow properties for achieving a qualitatively uniform colour impression when used in building materials and organic media are therefore the aim in the handling of pigments. This aim is more or less achieved by application of granulation methods to pigments.

In principle, the market requires pigment granules, regardless of the preparation process they originate from, to have two contradictory properties: mechanical stability of the granules and good dispersing properties in the medium used. The mechanical stability is responsible both for good transport properties during transport between manufacturer and user and for good metering and flow properties during the use of the pigments. It is brought about by high adhesive forces and depends, for example, on amount of binder and type of binder. On the other hand, the dispersibility is influenced by good milling prior to granulation (wet and dry milling), by the mechanical energy during the incorporation into the respective application medium (shear forces) and by dispersants which immediately reduce the adhesive forces in the granules on incorporation into a medium. For achieving the optimum colour impression, comminution of the pigment granules to give primary particles is necessary. In the case of inorganic pigments, the use of relatively large amounts of dispersants is limited owing to the auxiliary/pigment cost ratio. Moreover, a high proportion of auxiliary results in a corresponding reduction in the colour strength or the scattering power. Since the colour strength variations are in general less than ±5%, for example in the colouring of building materials, the use of additives is also limited even if they simultaneously act as adhesion promoters and dispersants. Furthermore, the additives must not adversely change the performance characteristics of the end products coloured therewith, such as, for example, building materials, asphalt, plastics, paints and finishes, for example the compressive strength or the setting behaviour in the case of concrete, the compressive strength or abrasion resistance in the case of asphalt and the strength or the notched impact strength in the case of plastics, the elastic properties in the case of elastomers (polymers) and the rheological properties in the case of paints and finishes. The water-soluble fractions should be very low in the case of pigments very generally and especially in the case of pigment granules, because water-soluble fractions can lead to problems in actually all application media.

For colouring building materials, such as, for example, concrete products, the pigments are used in some cases in the pulverulent state. In milled form, they have the advantage of good dispersibility. The complete and homogeneous distribution of such pigment powders takes place in a concrete mixer in a short time—as a rule within a few minutes. The disadvantage of these fine powders is that they do not have good flow behaviour and frequently agglomerate and form lumps during storage. They stick to packagings and machine parts, with the result that accurate metering during processing becomes difficult. A further disadvantage of the powders is that they tend to form dust.

Dust avoidance and improved metering during the use of pigments for colouring building materials are a primary aim. Since the end of the 1980s, this aim has been more or less achieved by applying granulation methods to pigments. Such granulation methods are, for example, pelletizing or granulation by spray drying.

Granulation by spray drying starts from pigment suspensions to which granule binders are added. The granulation by the spray drying method takes place cocurrently or countercurrently via one-material or two-material nozzles or via atomizing dryers, granules having a mean particle size of 50 to 500 μm being produced. The corresponding methods are described in numerous patents and are known to the person skilled in the art. In these methods, predominantly water-soluble binders are used. Thus, for example in DE 3 619 363 A1, organic substances, such as ligninsulphonates, formaldehyde condensates, gluconic acids, sulphated polyglycol ethers, are used as starting materials. Said substances act as superplasticizers in concrete mixes. They influence the water/cement ratio and affect the concrete consistency.

According to the teaching of DE 41 19 667 A1, it is also possible to use inorganic salts, such as, for example, phosphate, chloride and sulphate, of the cations of the two first main groups of the Periodic Table of the Elements. The amount of added readily soluble salts is 0.05 to 5% by weight, based on pigment. As already mentioned above, water-soluble fractions on pigment granules should be as low as possible. The explicit addition of readily soluble salt which then virtually completely enters the water-soluble fractions is therefore disadvantageous. The addition of chlorides is moreover disadvantageous if the pigment granules are to be used for colouring reinforced concrete, because chloride ions promote corrosion.

Owing to drop formation, spray granulation requires the use of readily flowable, i.e. low-viscosity, suspensions. Since a relatively large amount of water has to be evaporated for the drying process, the method is energy-consumptive and can be advantageously used especially when the pigments to be granulated are present in the wet phase, for example in an aqueous suspension or paste, as a result of the pigment preparation process. In the case of pigments which were prepared via a dry preparation process, for example an ignition process, spray granulation means an additional process step since the pigment already obtained in the dry state has to be suspended again in water and dried.

The pelletization can be carried out—starting from pigment powder—in mixers with high turbulence, in fluidized-bed processes or in rotating discs (pelletizing discs) or rotating drums (pelletizing drums). Common to all these processes is that the binder requirement, generally water, is high, so that drying must follow as an additional process step. Moreover, granules of different size are obtained in pelletization, particularly if insufficient binder is available for the amount of powder or the actual distribution is not optimal. A certain fraction of the granular particles may then be too large while on the other hand fractions which are too small and hence still form dust are present. Classification of the resulting granules with recycling of oversize and undersize is therefore required. Granulation in a rotating disc (pelletizing disc) leads to a broad particle size spectrum. When this is not desired owing to the poor dispersibility of granular particles which are too large, the granulation process must be followed by intensive monitoring by personnel and the preparation of granules must be optimized by manual control of the amount of nuclei. Usually, classification with recycling of the oversize and undersize is also effected here.

In addition to pelletization and granulation by spray drying, the prior art also describes other granulation processes. Thus, for example, EP 0 507 046 A1 discloses a combination of granulation by spray drying and pelletization. In recent years, it has increasingly also been possible for granules produced by briquetting and compression to become established on the market for colouring building materials. DE 196 38 042 A1 and DE 196 49 756 A1 describe inorganic pigment granules comprising dry pigments, for example finished material, obtained by mixing with one or more auxiliaries, compacting and further subsequent steps, such as comminution, sieving and recycling of oversize and/or fines. The granules obtained may be covered with an additional layer which serves for increasing the stability or as a processing aid. These granules have in the meantime had considerable commercial success in the colouring of building materials. Auxiliaries used may be both inorganic and organic auxiliaries. The inorganic auxiliaries used are substantially water-soluble salts, while various types of oils are suitable as organic auxiliaries. All these additives can be washed out (extracted or eluted) more or less rapidly with water. This situation is of course undesired because the auxiliary liberated can either enter the environment or the respective medium used, where damage then cannot be ruled out, particularly if oils are used as auxiliaries.

DE 43 36 613 A1 describes inorganic pigment granules comprising dry pigments, for example finished material, obtained by mixing with binders, compacting and further subsequent steps, such as granulation on a screen granulator and subsequent pelletization on a rotating disc or in a rotating drum. The pigment granules produced in this manner are suitable for colouring building materials, such as concrete or asphalt. In this process, water or aqueous solutions are used as binders. Water-insoluble binders, such as, for example, oils, can also be used.

DE 43 36 612 A1 describes a multistage process for the production of inorganic pigment granules comprising dry pigments by addition of oils. The pigment granules produced in this manner are suitable for colouring plastics and for the production of powder coatings.

Inorganic pigment granules which are suitable for colouring plastics or finishes and for the production of aqueous emulsion paints or tinting pastes are also mentioned in DE 197 04 943 A1. It describes inorganic pigment granules, inter alia for colouring building materials, finishes and plastics and for the production of aqueous emulsion paints, tinting pastes and slurries. The granules contain one or more water-soluble, hydrophilic or hydrophobic/hydrophilic auxiliaries which are liquid at 25° C. or mixtures of water-soluble, hydrophilic or hydrophobic/hydrophilic auxiliaries, which mixtures are liquid at 25° C., in an amount of 0.1 to 10% by weight. For the production of these granules, various production processes are mentioned, inter alia pelletization and granulation by spray drying and a compacting process. Here too, the addition of water-soluble auxiliaries which then remain on the granules and enter the water-soluble fractions is disadvantageous.

DE 100 03 248 A1 discloses pigment granules for colouring nonpolar media, such as asphalt, bitumen, bituminous substances, tar and plastics, which are produced from a mixture which comprises pigments, at least one composition which promotes the colouring and the distribution of the pigment in nonpolar media and/or at least one dispersant for polar systems and optionally solvents. The composition which promotes the colouring and the distribution of the pigment in nonpolar media should preferably be selected from the group consisting of the waxes. These are waxes of natural or synthetic origin. Synthetic waxes, such as polyalkylene waxes, polyethylene waxes, polyethylene glycol waxes, paraffin waxes, styrene-acrylate waxes, polytetrafluoroethylene waxes and the like, are preferably used. Like DE 197 04 943 A1, DE 100 03 248 A1 also describes a plurality of production processes for granules. However, these are only the processes already mentioned above, such as, for example, compression and briquetting processes, granulation by the spray drying process, fluidized-bed granulation or pelletization. In principle, the waxes described in DE 100 03 248 A1 have, from the point of view of their chemical nature, already been mentioned in other patents. They are organic compounds, and the granules produced can be used only for colouring nonpolar media.

The earlier prior art thus describes numerous pigment granules which can be produced by different processes. Almost always, solid or liquid organic auxiliaries are used for the granulation. Often, the organic auxiliaries are also water-soluble. However, even when inorganic auxiliaries are added, they are generally added in the form of aqueous salt solutions. The disadvantage of these substances is that they are washed out (extracted or eluted) more or less rapidly with water. This situation is of course undesired because the extracted or eluted auxiliary enters either the environment or the respective medium used, where damage can then not be ruled out. In purely inorganic systems, such as, for example, concrete, organic auxiliaries are foreign substances which may adversely affect the properties or the effects of which cannot be predicted.

DE 39 18 694 A1 discloses microgranules for colouring building materials, which microgranules are produced from an aqueous suspension of one or more pigments and compounds of boron, of aluminium, of silicon, of titanium, of zinc and/or of tin. Preferably, the compounds are present in the form of oxides and/or hydroxides and are borates, aluminates, silicates, titanates, zincates or stannates. The compounds can be added in the form of their solutions, as colloids or as suspensions in the entire process for the production of the granules, even during the actual pigment formation itself. In the examples disclosed, however, water-soluble compounds are generally used in the form of their solutions, such as, for example, soda waterglass or sodium aluminate, or liquid compounds, such as tetraethyl silicate or tetraethyl orthotitanate, are used. The addition of soda waterglass solutions or sodium aluminate or of tetraethyl silicate, which decomposes in aqueous solution in the spray drying process described to give silicic acid which then condenses, is disadvantageous since the granules show a very pronounced ageing effect. The dispersibility deteriorates in the course of a few weeks or months. This ageing effect is scarcely predictable since it depends, inter alia, on the storage temperature of the granules.

Very recently, granules comprising water-insoluble inorganic binders have also been proposed. Thus, in U.S. Pat. No. 6,596,072 B1, hydrophilic clay, preferably pozzolana, is added as a binder. DE 103 19 483 A1 discloses a dispersible pigment concentrate, inter alia for colouring building materials, such as concrete, which contains at least one pigment and optionally binder, dispersant and wetting agent, having a content of a disintegrant which, on contact with water (in a sufficient amount), brings about the substantial complete disintegration of the primary structure of the concentrate with liberation of the pigment within one minute without mechanical action. According to the teaching of DE 103 19 483 A1, such pigment concentrates disperse very rapidly and completely. Disintegrants used are preferably water-insoluble cellulose fibres having a particle size between 10 and 2000 μm. The pigment granules obtained are said to be suitable for the colouring of building materials, such as concrete, of plastics and synthetic resins and of paints and finishes. Pigment granules comprising large cellulose fibre particles are, however, completely unsuitable from the practical point of view for colouring paints, finishes and plastics. Large insoluble cellulose fibres lead to difficulties in the granulation by the spray drying process because the cellulose fibre-containing pigment suspension is sprayed through a very fine nozzle. This will clog up and become blocked in a relatively long duration of operation. The addition of cellulose fibres is therefore not equally suitable for every production process. A further disadvantage with the use of celluloses is their classification as substances associated with a dust explosion hazard. Celluloses are classified in dust explosion class 1, so that high safety requirements have to be met in their storage and in their handling in the granulation process. This safety aspect relates to all finely divided organic solids. The use of a disintegrant in the production of pigment granules has already been disclosed in DE 197 31 698 A1. It describes the use of disintegrants in the production of granules which are said to be suitable for colouring building materials or asphalt. A disintegrant generally comprises strongly hydrophilic polymers having a correspondingly great absorptivity for water. Such granules would not disperse sufficiently rapidly and well in an asphalt mixture since no water at all is present during the processing of asphalt. DE 100 02 559 B4 and DE 100 66 190 B4 have also already disclosed the use of disintegrants in the production of granules.

It was the object of the present invention to provide flowable, non-dusting and readily dispersible pigment granules without the use of disadvantageous additives. Preferably, the pigment granules should disintegrate on contact with water (in a sufficient amount) in a very short time without mechanical action, substantially complete disintegration of the primary structure of the granular particles occurring with release of the pigment.

Surprisingly, the object is achieved in a very outstanding manner by pigment granules containing one or more inorganic and/or organic pigments and at least one inorganic filter aid.

Preferably, the pigment granules according to the invention disintegrate on contact with water (in a sufficient amount, i.e. in a substantial excess) within less than 1 minute, particularly preferably within less than 30 seconds, without mechanical action, substantially complete disintegration of the primary structure of the granular particles occurring with release of the pigment.

In the context of the invention, “granules” is understood as meaning any material whose average particle size has been increased in comparison with the starting materials by a treatment step. “Granules” therefore comprises not only spray granules and compaction granules (granules produced by compression or briquetting) but also, for example, products of a wet or moist treatment with subsequent comminution, and products of dry or substantially dry processing steps, for example granules, briquettes and the like produced under dry conditions.

Filter aids are understood as meaning substances which permit as rapid formation as possible of a filter cake in the filtration of suspensions which are very finely divided or difficult to filter. Their presence results in many capillaries in the filter cake which are sufficiently small to retain the solids but also sufficiently numerous to permit optimum permeability.

Those inorganic filter aids which are virtually insoluble in water at 20° C. are particularly suitable. Their water solubility at 20° C. in neutral water is preferably less than 3% by weight, particularly preferably less than 0.5% by weight. Thus, the inorganic filter aids are virtually water-insoluble and therefore do not contribute to an increase in the water-soluble fractions in the pigment granules.

Preferably, the pigment granules according to the invention contain, as inorganic filter aids, silica gel, kieselguhr and/or perlite. The inorganic filter aids are substantially more finely divided than the disintegrants described in DE 103 19 483 A1 and are not associated with a dust explosion hazard. Moreover, they are also substantially more economical. In some cases, the prices of the commercially available inorganic filter aids are less than 25% of the prices of cellulose-based disintegrants.

Kieselguhr is used as a preferred filter aid. Kieselguhr—also referred to as diatomaceous earth, infusorial earth or mountain flour—is a very finely divided, loose, light, chalk-like, generally pale grey sediment belonging to the siliceous rocks. Kieselguhr consists of the silica skeletons, in a variety of shapes, of microscopic diatoms living since the Triassic era in fresh water, brackish water and salt water. Chemical analyses show in some cases only low contents of iron, aluminium, calcium, magnesium, manganese, titanium, sodium, potassium, phosphorus and sulphur.

Silica gels are used as filter aids which are likewise preferred. Silica gels—also referred to as silicic acid gels—are colloidal formed or unformed silicic acid of elastic to solid consistency having loose to dense pore structure and high adsorptivity for gases, vapours and liquids. The finely divided “pyrogenic” SiO₂ qualities prepared by flame pyrolysis of SiCl₄ are not included among the silica gels but among the silicic acids. These products, which are commercially available, for example, under the trade name Aerosil® from Evonik Industries (formerly Degussa), are not filter aids in the context of this invention.

Perlites are used as filter aids which are likewise preferred. Perlite (pearlstone) is a usually pale grey, also black volcanic glass of rhyolite composition, with 70 to 76% of SiO₂, 11 to 18% of Al₂O₃, 4 to 6% of K₂O and up to 7% of water. The name originates from the pearl-like appearance of the rock exhibiting conchoidal refraction, which appearance is due to small glass spheres from mm to cm in size and having a concentric shell-like structure. This product is noncombustible, resistant to weathering, does not rot and become moldy and is therefore suitable in a very outstanding manner as the filter aid.

The pigment granules preferably contain inorganic filter aids in a total amount of 0.01 to 10% by weight, preferably of 0.1 to 7.5% by weight, very particularly preferably of 0.1 to 3.5% by weight, based on the total amount of the pigment granules.

Inorganic filter aids may have different finely divided forms, which manifest themselves, inter alia, in their specific surface area, which can be measured by the BET one-point method according to DIN 66 131. The specific surface area of the inorganic filter aids may be between 2 and up to 800 m²/g and are preferably in this range. Preferably used inorganic filter aids are perlites having a specific surface area of 2 to 5 m²/g. The preferably used calcined or flux-calcined Kieselguhr has a specific surface area of 25 to 50 m²/g. The preferably used silica gels have specific surface areas of 100 to 400 m²/g.

In addition to the specific surface area, the average particle size and the particle size distribution also provide information about the finely divided nature of the filtration aid. Since the inorganic filter aids are generally water-insoluble compounds, their particle size can be measured very rapidly, conveniently and exactly using a laser defractometer.

The pigment granules preferably contain inorganic filter aids having a D₅₀ value of less than 80 μm, particularly preferably of less than 40 μm, according to the disclosed method of measurement. The D₅₀ value indicates the particle size at which 50% of the measured particles are smaller than the stated value (median particle size); the D₉₀ value accordingly indicates the particle size at which 90% of the measured particles are smaller than the stated value. The perlites are the coarsest of the inorganic filter aids. Dicalite® 478 and Dicalite® 4208 (commercial products from Dicalite Europe NV), which represent two typical members of perlite filter aids, both have a D₅₀ value of 26 μm and D₉₀ value of 55 μm and 56 μm, respectively. The particle size distribution is therefore very narrow. Consequently, these perlites are substantially more finely divided than celluloses, which can be used as disintegrants according to DE 103 19 483 A1. The D₅₀ value thereof is in general 100 μm or even substantially greater, and their D₉₀ value is 350 μm but may also be 1000 μm or more. Kieselguhr preferably has a D₅₀ value of less than 40 μm, particularly preferably of less than 30 μm. Silica gels may be even more finely divided.

Inorganic filter aids likewise preferably have a certain permeability and permeability cake density (PCD).

The various inorganic filter aids are distinguished as a rule by different PCD values. The pigment granules according to the invention preferably contain inorganic filter aids having a permeability cake density (PCD) in the range from 0.10 to 0.52 g/ml, particularly preferably from 0.15 to 0.46 g/ml, according to the method of measurement disclosed. The preferably used perlites are preferably in the range from 0.15 to 0.43 g/ml with respect to their PCD value. Perlites as filter aids form less dense filter cakes than kieselguhr. The preferably used kieselguhr is preferably in the range from 0.37 to 0.46 g/ml with respect to its PCD value.

A further important characteristic of filter aids is their permeability. The permeability of filter aids is stated in the Darcy unit and can be determined in standardized test apparatuses. One Darcy corresponds to the permeability through a 1 cm thick filter medium which permits a flow of 1 cm³ of liquid having a viscosity of 1 cP through an area of 1 cm² in 1 s under a pressure difference of 1 atm. The permeabilities of the inorganic filter aids can extend over a very wide range. The preferably used kieselguhr has permeabilities between 0.02 and 30.0 Darcy. Kieselguhr having a permeability of 0.025 to 8.0 Darcy is particularly preferably used. Preferably used perlites have permeabilities between 0.02 and 10 Darcy. Perlites having a permeability of 0.06 to 8.0 Darcy are particularly preferably used.

The pigment granules according to the invention may contain both organic and inorganic coloured pigments or achromatic pigments (black and white pigments). Iron oxide, titanium dioxide, chromium oxide, zinc oxide, manganese oxide, rutile mixed-phase pigments and carbon black (carbon pigments) and mixtures thereof are preferably used as inorganic pigments. Azo, quinacridone, phthalocyanine and perylene pigments and indigoids or mixtures thereof are preferably used as organic pigments. The use of one or more inorganic pigments as a mixture with one or more organic pigments is also conceivable. The use of metallic lustre pigments or effect pigments is also possible but less preferred.

The pigment granules according to the invention may optionally contain further auxiliaries. The pigment granules according to the invention preferably contain, as auxiliaries, wetting agents or dispersing additives or water or salts from the group consisting of the phosphates, phosphonates, carbonates, sulphates, sulphonates, aluminates, borates, titanates, formates, oxalates, citrates, tartrates, stearates, acetates, cellulose derivatives, such as, in particular, cellulose ethers or cellulose esters, phosphonocarboxylic acids, modified silanes, silicone oils, oils from biological cultivation (in particular rapeseed oil, soya bean oil, maize gem) oil, olive oil, coconut oil, sunflower oil), refined paraffinic and/or naphthenic mineral oils or synthetically produced oils.

The wetting agents are preferably gluconic acid, alkylbenzenesulphonates, fatty alcohol sulphates, fatty alcohol ether sulphates, sulphated polyglycol ethers, fatty alcohol ethoxylate, alkylphenol ethoxylate, alkylphenols, glycols, polyethers, polyglycols, polyglycol derivatives, ethylene oxide-propylene oxide copolymers, branched and/or straight-chain alkanesulphonates or olefin-sulphonates, branched and/or straight-chain alkanesulphates or olefin-sulphates and sulphosuccinates or solutions or mixtures or suspensions or emulsions thereof. The pigment granules according to the invention preferably contain polyethylene glycol.

The dispersing additives are preferably ligninsulphonates, melaminesulphonates, melamine-formaldehyde condensates, naphthalenesulphonates, alkylnaphthalenesulphonates, naphthalene-formaldehyde condensates, soaps, metal soaps, partly or completely hydrolysed polyvinyl alcohols, polyvinyl sulphates, polyacrylamides, polyacrylates, polyvinyl acetates, polycarboxylate ethers, polyhydroxy compounds, polyhydroxyamino compounds, medium- and long-chain alkanesulphates or alkanesulphonates or alkanesulphosuccinates and medium- and long-chain alkanephosphates or alkanephosphonates. The pigment granules according to the invention preferably contain ligninsulphonate.

The pigment granules according to the invention preferably contain auxiliaries in a total amount of 0.01 to 10% by weight, particularly preferably of 0.1 to 5% by weight, based on the pigment granules.

Fillers—also referred to as filling compositions, extending compositions or extenders. These are generally relatively economical substances which are mixed with the pigment granules in order to increase the volume and/or weight thereof but also in order to improve the technical properties. In principle, the admixing of the filler can be effected before or after the granulation. Preferably, the admixing of the fillers is effected before the granulation together with the inorganic filter aid or aids and optionally further auxiliaries, so that the filler particles are homogeneously distributed in the individual granular particles. Pigment granules which are homogeneous through and through can thus be obtained.

The fillers are preferably colourless inorganic or synthetic lamellar or non-lamellar particles which are particularly preferably selected from talc, mica, calcium carbonate, nylon powders, poly(β-alanine) powders, polyethylene powders, Teflon, lauroyllysine, boron nitride, bismuth oxychloride, polytetrafluoroethylene powders, polymethyl methacrylate powders, polyurethane powders, polystyrene powders, polyester powders, synthetic hollow microspheres, microsponges, microspheres comprising silicone resin, the oxides of zirconium and cerium, precipitated calcium carbonate or chalk, magnesium carbonate, magnesium bicarbonate, hydroxylapatite, hollow microspheres comprising silicic acids, microcapsules comprising glass or comprising ceramic, metal soaps which are derived from organic carboxylic acids having 8 to 22 carbon atoms and preferably having 12 to 18 carbon atoms, such as zinc stearate, magnesium stearate, lithium stearate, zinc laurate, magnesium myristate, and the polyethylene terephthalate/polymethacrylate polymers in the form of lamellae.

The pigment granules according to the invention preferably contain fillers in a total amount of not more than 40% by weight, particularly preferably of not more than 10% by weight, based on the pigment granules.

The pigment granules according to the invention are preferably distinguished in that at least 85% of the pigment granules have a particle size in the range from 60 to 3000 μm, particularly preferably in the range from 80 to 1500 μm.

The pigment granules according to the invention are preferably present as bead granules. Such bead granules are preferably obtained—starting from pigment suspensions or pigment pastes—by spray drying. In particular, spray dryers (atomizing dryers) which operate with spray discs or spray nozzles by the countercurrent or cocurrent method are used. The pigment granules obtained by this process have as a rule an average particle size in the range from 80 to 250 μm.

It is also preferable if the pigment granules according to the invention are present as compressed or briquetted granules. Such granules can also be produced starting from dry pigments, for example finished materials. The production process comprises at least one compression or briquetting step and further subsequent steps, such as comminution, screening and recycling of coarse and/or fine material. The granules obtained can be covered with an additional layer which serves for increasing the stability or as a processing aid. The compressed or briquetted granules may optionally be rounded by a rounding step before or after the coating, with the result that the flow behaviour is further improved.

The pigment granules according to the invention preferably have a residual water content of less than 5% by weight, particularly preferably of less than 4% by weight. This can optionally be achieved by subsequent drying.

The invention also relates to a process for the production of pigment granules, characterized in that one or more inorganic and/or organic pigments prepared in a known manner are mixed with at least one inorganic filter aid and optionally further auxiliaries and/or fillers and the mixture is subjected to a granulation process.

The production of the pigment granules according to the invention can be effected either starting from the dry pigment or in the wet phase (suspension or paste).

The production of the pigment granules according to the invention starting from the wet phase is particularly advantageous because numerous synthetically prepared pigments are synthesized in the wet phase. The separation of the solid from the liquid is then effected as a rule by filtration, this almost always also being followed by washing in order to wash the pigments salt-free. Pigments are generally very finely divided products since the pigment particles should be of the order of magnitude of the wavelength of visible light in order to achieve an optimum colour impression. The primary particles of the pigments are of the order of magnitude of about 1 μm. Such finely divided products are correspondingly difficult to filter so that the filtration and washing process acquire key importance in the overall working-up process in the pigment preparation. Thus, if the incorrect filter medium is chosen, a very large amount of solid can run through the filter and is then either lost as material passing through the filter or has to be recycled in a complicated manner. Both will lead to sensitive sacrifices in the cost-efficiency and the capacity of the production process. A very large amount of material passing through the filter may be, for example, the consequence of a filter medium having too coarse a pore structure. In the case of coloured pigments where the colour properties depend to a very great extent on the particle size and particle shape, the finely divided pigment particles in the pigment suspension may run through the filter medium and be lost as material passing through the filter, while the coarser particles are retained. As a result, however, the overall composition of the pigment paste then changes, which leads to more or less substantial and undesired colour changes. If on the other hand a filter medium having too fine a pore structure is used, the filtration and washing times increase very greatly. In the worst case, the filter medium is blocked within a very short time and the filtration process has to be stopped. In order to facilitate the filtration of particularly finely divided solid particles which are difficult to filter, filter aids can be used. If the admixing of the inorganic filter aid is effected before or during the filtration and/or washing of the pigments, the extremely positive effect of the filter aid can additionally be utilized in the solid/liquid separation and optionally also in the washing. Through their presence during the filtration and/or washing, the pigment loss as a result of material passing through the filter can be substantially reduced and optionally the filtration and washing times can also be shortened.

The mixing of the inorganic filter aid with one or more inorganic or organic pigments is preferably effected in the wet phase, after which the moist mixture is then subjected to a granulation process. The wet phase is preferably an aqueous suspension or paste from the pigment preparation process. The pigment suspension is preferably also subjected to dispersing before the mixing with the filter aid. During the dispersing, the pigment is preferably triturated between two surfaces or the pigment agglomerates are broken up by impact and shear forces which are produced by rapidly rotating discs. The combination of these two procedures is also possible. All dispersing apparatuses which operate according to these principles and are suitable for the dispersing of solid pigments in a liquid phase are known to the person skilled in the art. The pigment suspension prepared in this manner can then be mixed with the filter aid and fed to the filtration step.

In principle, it is also possible first to carry out the mixing of the inorganic filter aid with one or more inorganic or organic pigments in the wet phase and then to subject the finished mixture to a dispersing step. Then, not only pigment agglomerates but simultaneously also agglomerates or particles of the inorganic filter aid can be destroyed during the dispersing. For the dispersing, it is possible to use the same units as those already mentioned above. The prepared pigment/filter aid suspension can then be fed to the filtration step.

In principle, it is also possible to suspend the inorganic filter aid in order to then to meter it in liquid form to the pigment suspension or pigment paste. Water is preferably used as the suspension medium. Agglomerates of the inorganic filter aid can then be destroyed during the dispersing. The same units as those already mentioned above can be used for the dispersing. As a rule, it is completely sufficient if stirring units are used for the dispersing. The pigment/filter aid suspension prepared can then be fed to the filtration. In this case, the filter aid suspension is thus mixed with the pigment in the wet phase before or directly during the filtration by metering it into the pigment suspension or pigment paste. For example, it can be metered directly into the initially introduced filtration mixture or into the filter feed or into the filter tray. If the inorganic filter aid is mixed with the pigment in the wet phase before or during the filtration, the filter aid acts according to the so-called bodyfeed method (continuous metering). The slowly growing filter cake thus remains loose and permeable and the filter life is substantially increased.

Continuous or batchwise filtration apparatuses can be used for the filtration. The filtration can also be carried out under pressure or in vacuo.

In the continuous filtration, as can be carried out, for example, with the aid of vacuum drum filters, it is particularly advantageous if the filtration is carried out with the aid of a filter aid by the so-called precoat method. There, a thin layer of filter aid is first applied to the filter medium (precoat) before the actual filtration of the pigment suspension. This can be effected, for example, by first filtering the abovementioned filter aid suspension over the filter at the beginning of the filtration. A thin, generally 1.0 to 3.0 mm layer of filter aid builds up thereby on the filter medium. This subsequently protects the filter medium and ensures the discharge of a clear filtrate by retaining pigment particles on its surface. The precoat layer is most simply formed by pumping a filter aid suspension in circulation onto the filter medium. First the coarser particles are then deposited on the filter medium, followed by the finer ones. The application of the precoat layer is preferably effected at a rate of about 40 l/m²/min, but this value is only a guide value. If the filter aid suspension is in fact very viscous, substantially lower rates are then advantageous.

Regardless of whether the filtration of the pigment suspension is effected with an inorganic filter aid by the bodyfeed method or by the precoat method, it may in principle be advantageous to increase the added amount of filter aid above the level required for the pure filtration if pigment granules having improved properties can be produced thereby. Of course, it is also possible for the filtration process to have only the amount of filter aid added which is required for improving the filtration process and/or washing process. Preferably only the required amount of inorganic filter aid is added in the filtration process. Immediately after the filtration and/or washing, a further inorganic filter aid can then be added in each further process step. This need not necessarily be the identical inorganic filter aid with the aid of which the filtration was carried out. It may be entirely advantageous to add one or more other inorganic filter aids so that pigment granules which contain different filter aids are finally obtained.

As a rule, it is sufficient in the filtration of pigment suspensions with inorganic filter aids if only one filter aid is added. This applies both to the filtration by the precoat method and to the filtration by the bodyfeed method. Equally, it may be advantageous in the filtration and/or washing of certain pigments to use mixtures of a plurality of inorganic filter aids. The added amount of these filter aid mixtures may be over and above the level required for the pure filtration if pigment granules having improved properties can be produced thereby. For the filtration process it is of course also possible to add only the amount of a filter aid mixture which is required for improving the filtration and/or washing process. Preferably, only the required amount of a mixture of inorganic filter aids is added in the filtration process. Immediately after the filtration and/or washing, one or more further inorganic filter aids can then be added in each further process step.

The pigment which is removed from the filter after the filtration and optionally washing process contains the previously added inorganic filter aid or aids. If the filtration is effected by the bodyfeed method, the pigment/filter aid mixture removed from the filter medium is substantially homogeneous. In the case of the filtration by the precoat method, this cannot be assumed. In this case, a homogenization step is therefore preferably also carried out on the filter cake. This can be carried out either directly on the pasty filter cake by using, for example, mixers, screws, kneaders, roll mills, ball mills or stirred ball mills. The pasty pigment/filter aid filter cake then obtained can be used for the production of extruded granules or of pellets, but a drying step must then also follow. The pasty pigment/filter aid filter cake obtained can, however, also be dried, optionally milled and then subjected to a granulation process as dry pigment/filter aid mixture. In such a case, a compression or briquetting process is possible in order to produce pigment granules starting from a dry pulverulent pigment/filter aid mixture. If, however, the pasty pigment/filter aid filter cake obtained is diluted again with water or another liquid in a further processing because, for example, it is to be converted by spray granulation or fluidized-bed drying into bead granules, the homogenization is then preferably effected after the addition of water or of liquid because the viscosity decreases thereby so that stirring units or dissolvers can be used without problems for the preparation of a homogeneous suspension. The granulation process for the production of pigment granules according to the invention is preferably effected by spray drying or fluidized-bed drying.

The mixing of the inorganic filter aid with one or more inorganic or organic pigments is preferably effected in the wet phase and the moist mixture is subjected to a granulation process. Preferably, the wet phase is a further dispersion of agglomerated particles. By means of the further dispersing of already agglomerated particles, a pigment suspension or pigment paste for the reaction with one or more organic filter aids can be prepared in a targeted manner starting from pigment powders. Preferably, the pigment suspension or pigment paste is also subjected to dispersing prior to mixing with the filter aid. In principle, the same units can be used as already mentioned above if the wet phase is a suspension or paste from the pigment preparation process. As already described above, the filter aid can be metered in directly as solid or in the form of a previously prepared suspension of the pigment suspension or pigment paste. If the wet phase is a further dispersion of agglomerated particles, i.e. for example finished material, a further filtration and washing is no longer required, so that drying of the pigment/filter aid mixture can be effected directly. The units already mentioned above are available to the person skilled in the art for the drying step. The drying is preferably effected by spray drying or fluidized-bed drying. Spray dryers (atomizing dryers) which operate with spray discs or spray nozzles by the cocurrent or countercurrent method are preferably used, by means of which bead granules can be obtained.

In the case of pigments which can be readily filtered and for which the filtration and washing process need not necessarily be improved by addition of an inorganic filter aid, the addition of the inorganic filter aid or aids can also be effected only after the filtration. It is particularly advantageous in such a case if the filter cake is first dried and the mixing with one or more inorganic filter aids is effected in the dry state. A number of units is available to the person skilled in the art for the drying step. The drying is preferably effected by spray drying or fluidized-bed drying or with the aid of belt dryers. Depending on the chosen drying unit, a milling step may subsequently be necessary. Before or after the milling, further inorganic filter aids may additionally be added and mixed in. All customary industrial apparatuses can be used for the mixing. If only small amounts of one or more inorganic filter aids are mixed with a large amount of pigment, the preparation of a premix may be advantageous. The pigment/filter aid mixture obtained is then optionally milled.

The choice of the suitable granulation process depends, inter alia, on whether the inorganic filter aid or aids is or are added in the wet phase itself (suspension or paste) or is or are added to the previously dried pigment. The mixing of the inorganic filter aid with one or more inorganic or organic pigments is preferably effected in the dry phase, after which the dry mixture is then subjected to a granulation process. In this case, a compression or briquetting process or pelletization is advantageous. The granulation process for the production of pigment granules according to the invention is preferably a compression or briquetting process. Such a granulation process comprises one or more compression or briquetting steps with subsequent steps such as screening/milling, screening and recycling of coarse and/or fine material and optionally a rounding step or pelletization on a rotating disc (pelletizing disc), in a coating pan or in a rotating drum (pelletizing drum), in a screen unit or in a fluidized bed or in a fluid bed. Pure pelletization, as can be carried out traditionally on a rotating disc (pelletizing disc) or a rotating drum (pelletizing drum), in a mixer with high turbulence, is likewise possible.

During the production process, one or more fillers can also be added at any time. They can be added, for example, before or during or after the filtration. If the granulation is effected starting from dry powder, the filler or fillers can then also be added only after the drying and immediately before the granulation process. If the pigment powder or the pigment/filter aid mixture is also to be milled after the drying and before the granulation, the filler or fillers can then also be added prior to the milling.

One or more auxiliaries can also be added at any time during the production process. They can be added, for example, before or during or after the filtration. If they are water-soluble or elutable auxiliaries, they are added to the pigment/filter aid mixture preferably only after the filtration. If the granulation is effected starting from dried powder, the auxiliary or auxiliaries can then also be added only after the drying and immediately before the granulation process. If the pigment powder or the pigment/filter aid mixture is also to be milled after the drying and before the granulation, the auxiliary or auxiliaries can then also be added before the milling.

The pigment granules according to the invention are distinguished by good flowability, by a low dust fraction, by rapid disintegration in water and by high dispersibility in all media used.

The invention also relates to the use of the pigment granules according to the invention for colouring lime- and/or cement-bound building materials, such as concrete, cement mortar, render, lime sandstone, and for colouring asphalt and paper and for colouring organic media, such as finishes, plastics and pigment pastes, and for the production of emulsion paints and slurries. Lime- and/or cement-bound building materials in the context of this invention are preferably concrete, cement mortar, render and lime sandstone. The general term asphalt covers asphalt, bitumen, all bituminous substances and tar.

As a rule, the pigment granules are mixed directly with the lime- and/or cement-bound building materials before the mixing water is added to the mixture. Preferably, the pigment granules according to the invention are mixed with the lime- and/or cement-bound building materials in an amount of 0.1 to 10% by weight, based on cement, or, in the case of asphalt, in an amount of 0.1 to 10% by weight based on the total mixed material.

Since the pigment granules according to the invention have outstanding dispersibility when stirred or sprinkled into water, they can also be dispersed in the mixing water and the pigment suspension thus obtained can be mixed with the lime- and/or cement-bound building materials. Preferably, the pigment granules according to the invention are first suspended in water and then mixed with the lime- and/or cement-bound building materials.

Preferably, the pigment granules according to the invention are mixed with the organic media, the organic media preferably being powder coatings or plastics. Preferably, the plastics are thermoplastics, thermosetting plastics and/or elastomers. The pigment granules are preferably mixed with liquid plastics.

The organic media are preferably polymers having elastomeric properties.

The pigment granules according to the invention are preferably mixed with the emulsion paints or with water.

The subject of the present invention arises not only from the subject of the individual patent claims but also from the combination of the individual patent claims with one another. The same applies to all parameters disclosed in the description and any combinations thereof.

### EXAMPLES AND METHODS

The invention is illustrated in more detail with reference to the following examples without it being intended thereby to limit the invention.

### I. Description of the Measuring and Test Methods Used

### I.1 Building Material Colour Test

The determination of the dispersibility of building materials is effected in cement mortar via the colorimetric measurement of prisms produced with white cement with the following data:

Cement/quartz sand ratio 1:4, water/cement value 0.35, pigmentation level 1.2%, based on cement, mixer used from RK Toni Technik, Berlin, with 5 l mixing bowl, design 1551, speed 140 rpm, batch: 1200 g of 0.1 to 1 mm quartz sand, 600 g of 1 to 2 mm quartz sand, 200 g of limestone flour (<5% sieve residue on 90 μm sieve), 500 g of white cement. The quartz sand fractions and the limestone flour are initially introduced together into the mixing container. Thereafter, the pigment is added and premixed for 10 s (mixer speed 1: slow). The water is now added to this mixture, leaving it necessary to ensure that it is introduced into the centre of the mixture. After infiltration, the cement is added and mixed (mixer speed 1: slow). After a mixing time of 40 s, 55 s, 70 s, 85 s and 100 s, in each case samples of the mixture (300 g) are taken and test specimens (5×10×2.5 cm) are produced therefrom under pressure (pressure 114 kN for 2 seconds). Hardening of the test specimens: 24 hours at 30° C. and 95% relative humidity with subsequent drying for 4 hours at 60° C. Colour data measurement via Dataflash® 2000 Datacolor International, 4 measuring points per block. The mean values obtained are compared with the values of a reference sample. The colour difference ΔE_{ab}* and the relative colour strength (reference sample=100%) (CIELAB system (1976) as described in ASTM E 308 (2006) and ASTM D 2244 (1993)) are assessed. In the context of this application, the following colorimetric abbreviations and calculations are used, as are known from the CIELAB system (1976):

a* corresponds to the red-green axis with Δa*=a* (sample)×a* (reference)

b* corresponds to the yellow-blue axis with Δb*=b* (sample)×b* (reference)

L* corresponds to the lightness with ΔL*=L* (sample)×L* (reference)

ΔE_{ab}* corresponds to the colour difference, where (ΔE_{ab}*)²=(ΔL)²+(Δa*)²+(Δb*)², i.e. ΔE_{ab}*=[(ΔL)²+(Δa*)²+(ΔVb*)²]^{1/2}.

For the relative colour strength in percent, the following equations are applicable:

$$Relative colour strength in \% = \frac{{( K / S )}_{Sample}}{{( K / S )}_{Reference}} \cdot 100$$

$$K / S = \frac{{( 1 - {β}^{*} )}^{2}}{2 \cdot {β}^{*}}$$

$${β}^{*} = \frac{Y / 100 - {r}_{0}}{1 - {r}_{0} - {r}_{2} \cdot ( 1 - Y / 100 )} ,$$

where r₀=0.04 and r₂=0.6 and Y is the tristimulus value (lightness).

The dispersibility is designated as good in the case of a colour strength difference up to 5% compared with the reference sample and a colour difference ΔE_{ab}* of not more than 1.5 units.

### I.2 Determination of the Compressive Strength

The compressive strength was determined on the basis of DIN EN 196-1. The compressive strength of pigmented cement mortar is tested in comparison with an unpigmented sample, the differences not being permitted to be greater than specified in EN 12878 “Pigments for colouring lime- and/or cement-bound building materials” (not more than −8% for reinforced concrete).

### I.3 Determination of the Setting Behaviour

The setting behaviour was determined on the basis of DIN EN 196-3. The beginning of setting and the end of setting of cement slurry with and without pigmentation are compared with one another, the differences not being permitted to be greater than those specified in EN 12878.

### I.4 Dispersibility of Asphalt

The determination of the dispersibility in asphalt was effected by the following method: the pigment powder or pigment granules is or are mixed in a heatable laboratory mixer (Rego mixer) together with a road construction bitumen of the type B 80 (commercial product of Shell AG) and aggregates for 60 seconds at 180° C. Test specimens according to Marshall are produced with the mixture (“The Shell Bitumen Handbook, Shell Bitumen U.K., 1990, pages 230-232). Differences in shade between the Marshall bodies and a specified comparative sample comprising pigment powder are assessed colorimetrically by comparison of the red values a* (Minolta Chromameter II, standard illuminant C, CIELAB system (1976), as described in ASTM E 308 (2006) and ASTM D 2244 (1993)). Differences in the a* values of less than 0.5 units cannot be distinguished visually.

### I.5 Determination of the Residual Water Content

The residual water content (residual moisture) of the pigment granules is determined by gentle drying to constant weight.

### I.6 Determination of the Disintegration in Water

The investigation as to whether granules produce substantially complete disintegration of the primary structure of the granules with release of the pigment on contact with water in a sufficient amount within a short time without mechanical action is carried out by one of the methods described in DE 103 19 483 A1. The granules are combined with a sufficient amount of water in excess. This is effected under the microscope so that the disintegration of the granular particles can be readily observed.

### I.7 Determination of the Average Particle Size of Inorganic Filter Aids

The determination of the average particle size of inorganic filter aids is carried out using a Malvern MasterSizer MS-S (from Malvern Instruments Ltd.). The apparatus is a laser diffractometer (ISO 13320-1) which operates according to the principle of Fraunhofer diffraction. For wet measurements, a particle size range of 0.05 to 879 μm can be covered. For the particle size range between 0.05 and about 4 μm, the measured values are corrected by calculations according to the Mie theory. The apparatus has an integrated ultrasound tank with a capacity of 915 ml with inserted stirrer. The suspension is transported through the measuring cell by a pump in circulation with variable speed. For the measurement, about 100 mg of sample material are dispersed in 50 ml of 0.1% strength sodium hexametaphosphate solution for two minutes at 200 W input power by means of an ultrasound sonotrode (UP400S, from Hielscher Ultrasonics GmbH) with an interval of 1:1. This prepared suspension is introduced into the running internal ultrasound tank of the MasterSizer, filled with 0.1% strength sodium hexametaphosphate solution. Dilution is optionally effected with distilled water until the concentration display of the MasterSizer is in the ideal range. For the measurement, the following parameters should be set: pump speed 50%, ultrasonic power (only during the addition) 70% and stirring speed 50%.

### I.8 Determination of the Permeability Cake Density (PCD)

2.00 g of the filter aid are transferred to a 50 ml beaker and 35 ml of distilled water at 30° C. are added. The filter aid is suspended in water and transferred to a flow-through column having an internal diameter of 1.44 cm and a volume scale in ml. The flow-through column has a metal screen on which a filter paper (from Schleicher & Schuell GmbH) is placed. The flow-through column fits tightly on a vacuum suction bottle. After a part of the filter aid suspension has been transferred to the flow-through column, a pressure of 680 to 695 mbar is applied slowly to the vacuum suction bottle. The vacuum is kept constant in this range, for example via automatic regulation. The remainder of the filter aid suspension is stirred up again and poured into the flow-through column. The beaker is rinsed out with a small amount of distilled water at 30° C. and the rinsing water is likewise transferred to the flow-through column. The filter cake is then allowed to form. When about 1 ml of suspension is still standing above the filter cake, distilled water at 30° C. is added until the liquid column is a little above the 24 ml mark. The filter cake must always be prevented from running dry. When the meniscus of the liquid column passes the 16 ml mark, the volume of the wet filter cake is read on the scale of the flow-through column accurately to 0.1 ml. The filter cake must always be prevented from running dry and it must always be covered with sufficient water. The permeability cake density (PCD) can be easily calculated by the following formula:

$$PCD = \frac{m}{v} ,$$

where m is the mass of the filter aid used in grams (g) and v is the volume of the wet filter cake in ml. In the determination and calculation of the permeability cake density (PCD), filter aid fractions floating on the liquid column are, if appropriate, not taken into account. Thus, it is always only the filter cake formed on the filter which is taken into account. The permeability cake density (PCD) has the unit g/ml.

### II. EXAMPLES

### Example 1

Iron oxide red pigment Bayferrox® (commercial product of Lanxess Deutschland GmbH) was mixed with 3.0% by weight of a 40% strength ammonium ligninsulphonate solution and 1.5% by weight of Dicalite® 4208 (perlite and commercial product of Dicalite Europe NV) in a mixer for 15 minutes. The mixture was pressed on a 200/50 compactor (from Bepex, Leingarten) at about 17 kN (3.4 kN/cm) and then comminuted on a crusher (from Frewitt, Fribourg, Switzerland) with a screen of 1.5 mm mesh size. The comminuted product was screened over a screen of 315 μm mesh size. The granules obtained as oversize are dust-free and readily flowable. They have a residual water content of 0.40% by weight and a bulk density of 1.06 g/cm³. On contact with a sufficient amount of water, the granules disintegrate abruptly even without mechanical action, so that complete disintegration of the primary structure of the granular particles has occurred after only less than 30 seconds.

The pigment granules are incorporated according to the test described into an asphalt mixture by producing a test specimen according to Marshall. The Marshall body which had been coloured with the Bayferrox® 130 powder used for the granulation served as a comparative sample. No difference can be detected visually between the two test specimens. The difference in the a* value between the two test specimens is −0.1 unit. The pigment granules are therefore outstandingly dispersible in asphalt.

The pigment granules were incorporated according to the building material colour test described into a building material mixture. On the test specimen coloured with pigment granules, a relative colour strength of 96% with a colour difference ΔE_{ab}* 1.1 units is measured after a dispersing time of 55 s, and a relative colour strength of 101% with a colour difference of ΔE_{ab}* of 0.8 unit after a dispersing time of 70 s. The pigment granules are therefore completely dispersed after 70 s. On the test specimens which had been coloured with the Bayferrox® 130 powder used for the granulation, a relative colour strength of 98% is measured after a dispersing time of 55 s and of 100% after a dispersing time of 70 s (reference sample for the total measurement series). The pigment granules are therefore outstandingly dispersible in the building material. Their colouring effect is comparable with that of the Bayferrox® 130 powder used for the granulation. Surprisingly, the colour values are even more saturated in the case of granules containing filter aid.

### Example 2

Iron-oxide red pigment Bayferrox® 130 was mixed with 1.5% by weight of polyethylene glycol (average molecular weight about 400) and 2.0% by weight of Dicalite® 478 (perlite and commercial product of Dicalite Europe NV) in a mixer for 15 minutes. The mixture was pressed on a 200/50 compactor (from Bepex, Leingarten) at about 17 kN (3.4 kN/cm) and then comminuted on a crusher (from Frewitt, Fribourg, Switzerland) with a screen of 1.5 mm mesh size. The comminuted product was screened over a screen of 315 μm mesh size. The granules obtained as oversize are dust-free and readily flowable. They have a residual water content of 0.73% by weight and a bulk density of 1.07 g/cm³. On contact with a sufficient amount of water, the granules disintegrate abruptly even without mechanical action, so that complete disintegration of the primary structure of the granular particles has occurred after only less than 30 seconds. The described rapid disintegration of the granules on contact with a sufficient amount of water also occurs after months. An ageing effect is therefore not to be found.

The comparison of the compressive strength of a sample of pigmented cement mortar with an unpigmented sample gives a difference of −4%. The granules therefore meet the requirements of EN 12878. This also applies to the setting behaviour. No difference is detectable compared with a cement slurry without pigment.

### Example 3

The mixture described in example 2 was pressed on a 200/50 compactor at about 24 kN (4.8 kN/cm) and then comminuted on a crusher with a screen of 1.5 mm mesh size. The comminuted product was screened over a screen of 315 μm mesh size. The granules obtained as oversize are dust-free and readily flowable. They have a residual water content of 0.51% by weight and a bulk density of 1.08 g/cm³. On contact with a sufficient amount of water, the granules disintegrate abruptly even without mechanical action, so that complete disintegration of the primary structure of the granular particles has occurred after only less than 30 seconds. The described rapid disintegration of the granules on contact with a sufficient amount of water occurs even after months. An ageing effect is therefore not to be found.

The comparison of the compressive strength of a sample of pigmented cement mortar with an unpigmented sample gives a difference of −1%. The granules therefore meet the requirements of EN 12878. This also applies to the setting behaviour. Only a difference of 5 minutes is detectable compared with a cement slurry without pigment.

### Example 4

An iron oxide black pigment prepared by the precipitation process from iron(II) sulphate was filtered after synthesis and washed salt-free. The filter cake was suspended again with water and finally contained 2.0% by weight of Dicalite® 4208. 3.0% by weight of a 40% strength ammonium ligninsulphonate solution were additionally added. The suspension having a solids content of 52% was dried via a nozzle spray dryer. The granules obtained are dust-free and readily flowable. They had a residual water content of 0.34% by weight and a bulk density of 1.20 g/cm³. For comparison purposes, a sample without any additives was also dried via the nozzle spray dryer. The comparative material obtained is substantially more poorly flowable and has a stronger tendency to form dust. In the absence of an auxiliary, the comparative material is not sufficiently stable for granules.

The pigment granules were incorporated into a building material mixture according to the building material colour test described. On the test specimens coloured with pigment granules containing filter aid, a relative colour strength of 94% with a colour difference ΔE_{ab}* of 0.7 unit is measured after a dispersing time of 40 s, and a relative colour strength of 99% with a colour difference ΔE_{ab}* of 0.2 unit after a dispersing time of 55 s. The pigment granules are therefore completely dispersed after 55 s. On the test specimens which had been coloured with the comparative material, a relative colour strength of 92% is measured after 40 s and one of 98% after a dispersing time of 55 s (reference sample for the total measurement series is the comparative sample with a dispersing time of 70 s). The pigment granules containing filter aid are therefore outstandingly dispersible in the building material.

### Example 5

An iron oxide black pigment prepared by the precipitation method from iron(II) sulphate was filtered after synthesis and washed salt-free. The filter cake was suspended again with water and finally contained 2.0% by weight of Dicalite® 4208. Drying was effected via a spray dryer. The material obtained was milled via a Bauermeister mill with 3 mm screen insert, and the powder containing filter aid was pressed on a 200/50 compactor at about 9 kN (1.8 kN/cm) and then comminuted on a crusher with a screen of 1.5 mm mesh size. The comminuted product was screened over a screen of 315 μm mesh size. The granules obtained as oversize are dust-free and readily flowable. They have a residual water content of 2.5% by weight and a bulk density of 1.18 g/cm³. On contact with a sufficient amount of water, the granules disintegrate even without mechanical action in less than 30 seconds with complete disintegration of the primary structure of the granular particles.

The pigment granules were incorporated into a building material mixture according to the building material colour test described. On the test specimens coloured with pigment granules containing filter aid, a relative colour strength of 85% with a colour difference ΔE_{ab}* of 1.8 units is measured after a dispersing time of 40 s and a relative colour strength of 101% with a colour difference ΔE_{ab}* of 0.2 unit after a dispersing time of 55 s. The reference sample for the total measurement series is the comparative sample after a dispersing time of 70 s. The comparative sample is the Dicalite®-free iron oxide black pigment used, after filtration, washing, drying and milling. The pigment granules containing filter aid are therefore outstandingly dispersible in the building material.

### Example 6 (Comparative Example to Example 7)

Iron oxide yellow pigment Bayferrox® 920 was mixed with 2.5% by weight of Arbocel® FT 600-30 (cellulose-based disintegrant, commercial product of J. Rettenmaier & Söhne GmbH+Co, according to DE 103 19 483 A1) in a mixer for 15 minutes. The mixture was pressed on a 200/50 compactor at about 16 kN (3.2 kN/cm) and then comminuted on a crusher with a screen of 1.5 mm mesh size. The comminuted product was screened over a sieve of 315 μm mesh size. The granules obtained as oversize are dust-free and readily flowable. They have a residual water content of 0.89% by weight and a bulk density of 0.73 g/cm³. On contact with a sufficient amount of water, the granules disintegrate even without mechanical action in less than 30 seconds, like the granules in DE 103 19 483 A1. In less than 30 seconds, complete disintegration of the primary structure of the granular particles has occurred.

The pigment granules were incorporated into a building material mixture according to the building material colour test described. The development of the relative colour strength after 40, 55, 70, 86 and 100 s and the respective associated colour differences ΔE_{ab}* are summarized in Table 1.

### Example 7

Iron oxide yellow pigment Bayferrox® 920 was mixed with 2.5% by weight of a 40% strength ammonium ligninsulphonate solution and 1.0% by weight of Dicalite® 4208 in a mixer for 15 minutes. The mixture was pressed on a 200/50 compactor at about 16 kN (3.2 kN/cm) and then comminuted on a crusher with a screen of 1.5 mm mesh size. The comminuted product was screened over a screen of 315 μm mesh size. The granules obtained as oversize are dust-free and readily flowable. They have a residual water content of 0.91% by weight and a bulk density of 0.76 g/cm³. On contact with a sufficient amount of water, the granules disintegrate abruptly even without mechanical action, so that complete disintegration of the primary structure of the granular particles has occurred after only less than 30 seconds.

The pigment granules were incorporated into a building material mixture according to the building material colour test described. The development of the relative colour strength after 40, 55, 70, 86 and 100 s and the respective associated colour differences ΔE_{ab}* are summarized in Table 1. It is evident that the pigment granules containing filter aid are very readily dispersible since a relative colour strength of 96% is reached after only 70 s. The dispersibility is at least as good as that of the granules described in the prior art (Example 6).

TABLE 1
Colour strengths and respective associated colour differences
ΔE_{ab}* as a function of the dispersing time for Examples 6 and 7.

| | | | Example 6 | |
|---|---|---|---|---|
| | Example 7 | | (comparative example) | |
| | Relative | Colour | Relative | Colour |
| Dispersing | colour | difference | colour | difference |
| time | strength | ΔE_{ab}* | strength | ΔE_{ab}* |
| 40 s | 87% | 1.9 | 83% | 2.7 |
| 55 s | 90% | 1.1 | 91% | 1.2 |
| 70 s | 96% | 0.4 | 93% | 0.7 |
| 85 s | 100% | 0.2 | 96% | 0.4 |
| 100 s | 100% | 0.0 (reference) | 98% | 0.3 |
| | (reference) | | | |

1. Pigment granules containing one or more inorganic and/or organic pigments and at least one inorganic filter aid.

2. Pigment granules according to claim 1, characterized in that the inorganic pigments are selected from at least one iron oxide, titanium dioxide, chromium oxide, zinc oxide, manganese oxide, rutile mixed-phase pigments, carbon black (carbon pigments) or mixtures thereof.

3. Pigment granules according to claim 1, characterized in that the organic pigments are selected from at least one azo, quinacridone, phthalocyanine and perylene pigments, indigoids or mixtures thereof.

4. Pigment granules according to claim 1, characterized in that the inorganic filter aids are selected from at least one silica gel, kieselguhr, perlite or mixtures thereof.

5. Pigment granules according to claim 1, characterized in that the pigment granules contain one or more inorganic filter aids having a D₅₀ value of less than 80 μm, according to the disclosed method of measurement.

6. Pigment granules according to claims 1, characterized in that the pigment granules contain one or more inorganic filter aids having a D₅₀ value of less than 40 μm, according to the disclosed method of measurement.

7. Pigment granules according to claims 1, characterized in that the pigment granules disintegrate on contact with water (in a sufficient amount) within less than 1 minute, without mechanical action.

8. Pigment granules according to claim 1, characterized in that the pigment granules disintegrate on contact with water (in a sufficient amount) within less than 30 seconds, without mechanical action.

9. Pigment granules according to claim 1, characterized in that the pigment granules contain one or more inorganic filter aids in a total amount of 0.01 to 10% by weight, based on the total amount of pigment granules.

10. Pigment granules according to claim 1, characterized in that the pigment granules contain one or more inorganic filter aids in a total amount of 0.1 to 7.5% by weight, based on the total amount of pigment granules.

11. Pigment granules according to claim 1, characterized in that the pigment granules contain wetting agents or dispersing additives or water or salts selected from the group consisting of the phosphates, phosphonates, carbonates, sulphates, sulphonates, aluminates, borates, titanates, formates, oxalates, citrates, tartrates, stearates, acetates or cellulose derivatives, phosphonocarboxylic acids, modified silanes, silicone oils, oils from biological cultivation, refined paraffinic and/or naphthenic mineral oils or synthetically produced oils as auxiliaries.

12. Pigment granules according to claim 11, characterized in that cellulose derivatives are selected from at least one cellulose ether or cellulose ester or mixtures thereof.

13. Pigment granules according to claim 11, characterized that the oils from biological cultivation are selected from at least one rapeseed oil, soya bean oil, maize germ oil, olive oil, coconut oil or, sunflower oil or mixtures thereof.

14. Pigment granules according to claim 11, characterized in that the wetting agents are selected from gluconic acid, alkylbenzenesulphonates, fatty alcohol sulphates, fatty alcohol ether sulphates, sulphated polyglycol ethers, fatty alcohol ethoxylate, alkylphenol ethoxylate, alkylphenols, glycols, polyethers, polyglycols, polyglycol derivatives, ethylene oxide-propylene oxide copolymers, branched and/or straight-chain alkanesulphonates or olefin-sulphonates, branched and/or straight-chain alkanesulphates or olefin-sulphates and sulphosuccinates or solutions or mixtures or suspensions or emulsions thereof.

15. Pigment granules according to claim 11, characterized in that the dispersing additives are selected from ligninsulphonates, melaminesulphonates, melamine-formaldehyde condensates, naphthalenesulphonates, alkylnaphthalenesulphonates, naphthalene-formaldehyde condensates, soaps, metal soaps, partly or completely hydrolysed polyvinyl alcohols, polyvinyl sulphates, polyacrylamides, polyacrylates, polyvinyl acetates, polycarboxylate ethers, polyhydroxy compounds, polyhydroxyamino compounds, medium- and long-chain alkanesulphates or alkanesulphonates or alkanesulphosuccinates and medium- and long-chain alkanephosphates or alkanephosphonates or mixtures thereof.

16. Pigment granules according to claim 1, characterized in that the pigment granules contain auxiliaries in a total amount of 0.01 to 10% by weight, based on the pigment granules.

17. Pigment granules according to claim 1, characterized in that the pigment granules contain auxiliaries in a total amount of 0.1 to 5% by weight, based on the pigment granules.

18. Pigment granules according to claim 1, characterized in that the pigment granules contain fillers in a total amount of not more than 40% by weight, based on the pigment granules.

19. Pigment granules according to claim 1, characterized in that the pigment granules contain fillers in a total amount of not more than 10% by weight, based on the pigment granules.

20. Pigment granules according to claim 18, characterized in that the fillers differing from the pigments are colourless inorganic or synthetic lamellar or non-lamellar particles which are selected in particular from talc, mica, calcium carbonate, nylon powders, poly(β-alanine) powders, polyethylene powders, Teflon, lauroyllysine, boron nitride, bismuth oxychloride, polytetrafluoroethylene powders, polymethyl methacrylate powders, polyurethane powders, polystyrene powders, polyester powders, synthetic hollow microspheres, microsponges, microspheres comprising silicone resin, the oxides of zirconium and cerium, precipitated calcium carbonate or chalk, magnesium carbonate, magnesium bicarbonate, hydroxylapatite, hollow microspheres comprising silicic acids, microcapsules comprising glass or comprising ceramic, metal soaps which are derived from organic carboxylic acids having 8 to 22 carbon atoms and preferably having 12 to 18 carbon atoms, such as zinc stearate, magnesium stearate, lithium stearate, zinc laurate, magnesium myristate, and the polyethylene terephthalate/polymethacrylate polymers in the form of lamellae.

21. Pigment granules according to claim 1, characterized in that at least 85% of the pigment granules have a particle size in the range from 60 to 3000 μm.

22. Pigment granules according to claim 1, characterized in that at least 85% of the pigment granules have a particle size in the range from 80 to 1500 μm.

23. Pigment granules according claim 1, characterized in that the pigment granules are present as bead granules.

24. Pigment granules according to claim 1, characterized in that the pigment granules are present as compressed or briquetted granules.

25. Pigment granules according to claim 1, characterized in that the pigment granules have a residual water content of less than 5% by weight.

26. Pigment granules according to claim 1, characterized in that the pigment granules have a residual water content of less than 4% by weight

27. Process for the production of pigment granules according to claim 1, characterized in that one or more inorganic and/or organic pigments are mixed with at least one inorganic filter aid and optionally further auxiliaries and/or fillers and the mixture is subjected to a granulation process.

28. Process for the production of pigment granules according to claim 27, characterized in that the mixing of the inorganic filter aid with one or more inorganic or organic pigments is effected in the wet phase.

29. Process for the production of pigment granules according to claim 28, characterized in that the wet phase is an aqueous suspension or paste from the pigment preparation process.

30. Process for the production of pigment granules according to one or more of claims 27, characterized in that the granulation process is effected by spray drying or fluidized-bed drying.

31. Process for the production of pigment granules according to claim 27, characterized in that the mixing of the inorganic filter aid with one or more inorganic or organic pigments is effected in the dry phase.

32. Process for the production of pigment granules according to claim 31, characterized in that the granulation process is a compression or briquetting process.

33. A method of colouring lime-bound and/or cement-bound building materials, or asphalt, paper, or organic media or emulsion paints and slurries with the pigment preparation according to claim 1, comprising: admixing the pigment preparation with the lime-bound and/or cement-bound building materials, or asphalt, paper, or organic media or emulsion paints and slurries.
